(19) United States
(12) Patent Application Publication
(10) Pub. No.: US 2022/0198398 A1
(43) Pub. Date: Jun. 23, 2022

(54) CANDIDATE MATCHING SYSTEM

(71) Applicant: ZIIGRA INC., Scarborough (CA)

(72) Inventor: Rushbh GUDKA, Mississauga (CA)

(21) Appl. No.: 17/545,659

(22) Filed: Dec. 8, 2021

Related U.S. Application Data
(60) Provisional application No. 63/129,226, filed on Dec. 22, 2020.

(51) Int. Cl. G06Q 10/10; G06Q 10/06

(52) U.S. Cl. CPC G06Q 10/1053; G06Q 10/063112

(57) ABSTRACT

A candidate schema is received from a recommending terminal. The candidate schema is configured to store subjective information about a candidate. The candidate schema is stored in memory that also stores a database of candidates. The candidate schema is associated with the candidate in the database of candidates. The candidate schema is translated into a normalized schema, and the memory is configured to further store the normalized schema. The normalized schema is associated with a candidate in the database of candidates. The normalized schema is configured to store measurable data about the candidate. A job description for an employment position is received from a hiring terminal through the communications interface. Candidate matches are determined between the normalized schema and the job description for the employment position. The candidate matches are sent to the hiring terminal through the communications interface to be displayed on a graphical interface on the hiring terminal.

### FIELD

The present disclosure relates to a computerized matching or recommendation system.

### BACKGROUND

Matching candidates to employment is generally a human exercise that may be supplemented by computer systems. The process is often reliant on human factors that are difficult to determine accurately. Further, there are often inefficiencies in communications surrounding a conventional matching process and unnecessary duplication of effort, which may manifest as a waste computational resources.

### SUMMARY

In various examples, a candidate schema is received from a recommending terminal through a communications interface. The candidate schema is configured to store subjective information about a candidate. The candidate schema is stored in memory. The memory also stores a database of candidates. The candidate schema is associated with the candidate in the database of candidates. The candidate schema is translated into a normalized schema, and the memory is configured to further store the normalized schema. The normalized schema is associated with a candidate in the database of candidates. The normalized schema is configured to store measurable data about the candidate. A job description for an employment position is received from a hiring terminal through the communications interface. Candidate matches are determined between the normalized schema and the job description for the employment position. The candidate matches are sent to the hiring terminal through the communications interface to be displayed on a graphical interface on the hiring terminal.

### BRIEF DESCRIPTION OF THE DRAWINGS

FIG. 1 is a diagram of an example candidate matching system.

FIG. 2 is a flowchart of an example of the processor interacting with the recommending terminal and the hiring terminal to obtain candidate matches.

FIG. 3 is a diagram of the example candidate matching system in FIG. 1 where the server is receiving a candidate schema.

FIG. 4 is a diagram of the example candidate matching system in FIG. 1 where the processor is translating a candidate schema into a normalized schema.

FIG. 5 is a diagram of the example candidate matching system in FIG. 1 where the server is receiving a job description.

FIG. 6 is a diagram of the example candidate matching system in FIG. 1 where the job description is stored in the memory of the server.

FIG. 7 is a diagram of the example candidate matching system in FIG. 1 where the normalized schemas of the candidates that were matched with the job description are sent to the hiring terminal.

FIG. 8 is an alternative embodiment of an example candidate matching system with candidate terminals.

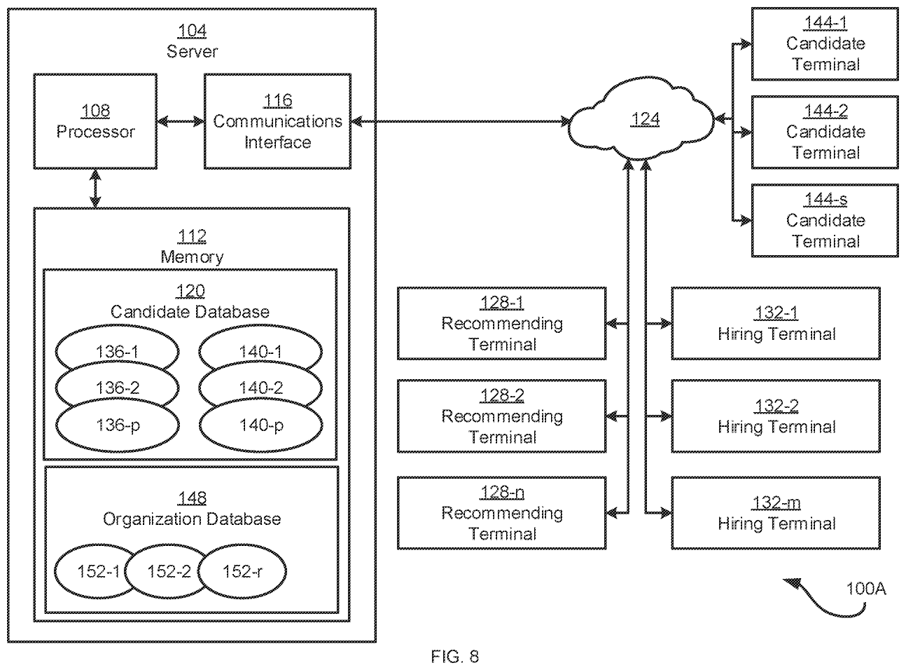

FIG. 9 is an alternative embodiment of an example candidate matching system with job rubrics.

### DETAILED DESCRIPTION

Matching candidates (also referred to herein as potential employees) to jobs and employers has always been a tricky proposition, as it entails taking two parties who are strangers to each other, and trying to determine whether the candidate is a good fit for the employer, and whether the candidate has the necessary prerequisite skills. An interview process may alleviate some of those concerns, however, it is still difficult to determine whether the candidate is truthful in depicting their skill set.

This disclosure relates to using a candidate matching system, where candidates are recommended by a third party, where other potential employers can verify that the candidate has certain skill sets, such as programming, or project management, or that can verify that the candidate has certain soft skills, such as the ability to work in a team, or if the candidate is a self-starter. This disclosure further relates to using a normalized schema to help employers compare candidates and to translate the candidate's subjective qualities into objective and numerically measurable statistics.

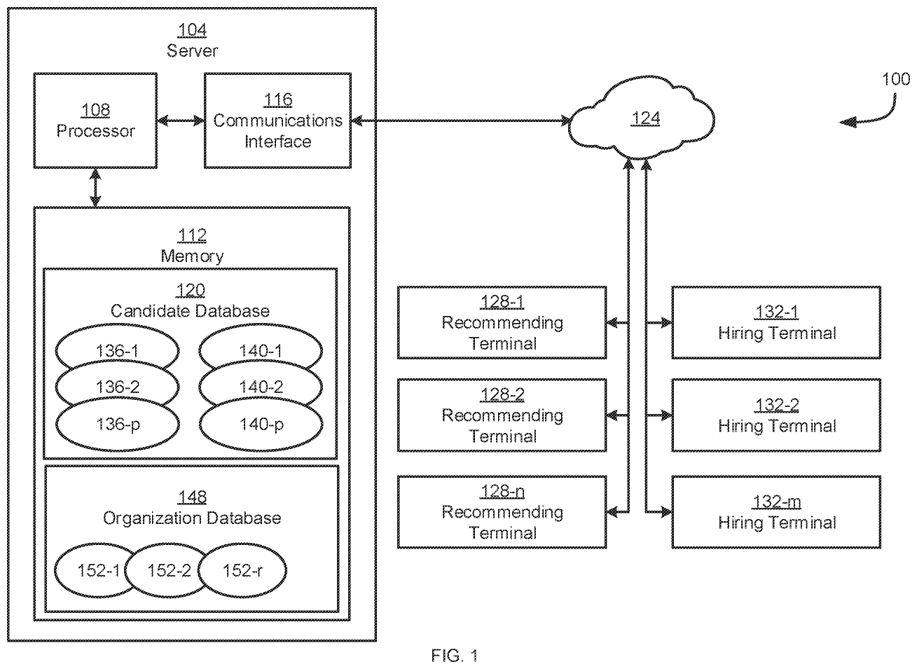

FIG. 1 shows an example candidate exchange system 100. Candidate exchange system 100 includes server 104, network 124, recommending terminals 128, and hiring terminals 132. (Recommending terminals 128-1, 128-2 . . . 128-n are referred to herein individually as recommending terminal 128 and collectively as recommending terminals 128. Hiring terminals 132-1, 132-2 . . . 132-m are referred to herein individually as hiring terminal 132 and collectively as hiring terminals 132. This nomenclature is used elsewhere herein.) Recommending terminals 128 and hiring terminals 132 are connected to server 104 through network 124.

Server 104 can be any suitable type of computing device, such as for example, a desktop computer, a laptop computer, a gaming console, a smartphone, tablets, or the like. Other suitable devices may be contemplated.

Server 104 includes processor 108, memory 112 and communications interface 116. Memory 112 includes a non-transitory computer-readable medium that may include volatile storage, such as random-access memory (RAM) or similar, and may include non-volatile storage, such as a hard drive flash memory, and similar.

Memory 112 stores candidate database 120 and organization database 148. Candidate database 120 stores a list of candidates and their basic information, including, but not limited to, their name, phone number and email. Candidate database 120 also stores candidate schema 136 and normalized schema 140.

Candidate schema 136 contains subjective data (also referred to herein as subjective information) regarding a candidate. For each candidate in candidate database 120, there may be a corresponding candidate schema 136 Subjective data regarding a candidate may include their expertise in skill sets, whether the candidate is a team player, whether the candidate is a self-starter, or other information regarding a candidate's personality. The subjective data is provided from recommending terminal 128, and is the evaluation and viewpoint of a candidate from the user of recommending terminal 128. For example, the user of recommending terminal 128 may be the previous employer of a candidate, and may believe that the candidate is a valuable resource that can contribute to other employers. The user of recommending terminal 128 may submit subjective data about the candidate, such as an evaluation of the time that the candidate spent with the previous employer, and the believed level of expertise of the candidate in certain skills. The subjective data received can then be saved or converted into candidate schema 136.

Subjective data may be gathered through a graphical interface on recommending terminal 128. The graphical interface may present a series of questions regarding the candidate to obtain the subjective data for the candidate. Questions that are presented to the user of recommending terminal 128 can range from simple yes or no answer type questions, to more complex questions where paragraphs of text may be the requested. For example, a simple yes or no question that may be posed to the user of recommending terminal 128 may be “Is the candidate a team player?”. A more complex question that may be posed may be “Provide an example situation or project when the candidate displayed team player qualities?”. Other questions to gather subjective data may be contemplated.

Alternatively, the graphical interface on recommending terminal 128 may also present a form upon which skills are presented, and the user of recommending terminal 128 may comment on each skill in a text based field.

Subjective data that has been gathered through recommending terminal 128 is converted into a candidate schema 136. Candidate schema 136 is composed of subjective data in a formatted package that can be stored in memory 112. An example of a formatted package is an XML file, or an HTML file. Other file types or formatted data packages may be contemplated.

Conversion of the subjective data into candidate schema 136 may occur at recommending terminal 128, or may be converted by processor 108. If conversion of subjective data into candidate schema 136 occurs at recommending terminal 128, then candidate schema 136 is sent to server 104 via network 124 and received by communications interface 116 to be stored in memory 112. If conversion of subjective data into candidate schema 136 occurs at processor 108, then subjective data is sent via network 124 and received by communications interface 116, where processor 108 converts the subjective data into candidate schema 136, and then it is stored in memory 112.

Normalized schema 140 contains objective and numeric data regarding a candidate. For each candidate in candidate database 120, there may be a corresponding normalized schema 140. Normalized schema 140 is obtained by processor 108 translating candidate schema 136 into measurable data. This may be done through various algorithms or may be achieved through machine learning or artificial intelligence.

For example, if the subjective data in candidate schema 136 states “yes” for the question of “Is the candidate a team player?”, then processor 108 may translate this into measurable data in normalized schema 140 as a binary setting of 1 for the field of “team-player”, where 1 is directly translated from the subjective data of “yes”.

In another example, where the subjective data is more complex, if in the subjective data, the question of “Is the candidate a team player?” was presented to the user of recommending terminal with multiple options for answers (ie. multiple choice), where the possible answers were “Never”, “Not really”, “Sometimes”, “Often”, and “Always”, then normalized schema 140 may have a numeric setting of 1, 2, 3, 4, and 5 for each answer.

In another example, where the subjective data is more complex, if in the subjective data, the question of “Provide an example situation or project when the candidate displayed team player qualities?” contains a text based answer, machine learning may be used to determine a numerical value of a candidate's ability to work within a team. This may be accomplished by feeding multiple examples of answers, and expected numerical values to processor 108, and creating a machine learning module. The machine learning component will then be able to extrapolate a numerical value for a new candidate from candidate schema 136 based on previous examples in the machine learning module.

Machine learning may similarly be used in an example where a form was provided to the user of recommending terminal 128, and text based answers were provided in response. Other forms of converting candidate schema 136 to normalized schema 140 may be contemplated.

Normalized schema 140 may also contain universal categories, including, but not limited to, innovation & results, communications, cultural fit, and analytical thinking. The universal categories may be used when evaluating a candidate against different roles or job descriptions. Universal categories may be calculated through an algorithm through multiple numerical values from different answers, or they may be limited to a single value from a single answer.

Universal categories in normalized schema may change over time, in order to improve the accuracy of scoring candidates. This is done based on feedback from users.

For example, if there are two communications based answers from candidate schema 136 that were converted into numerical values in normalized schema 130, then the communications universal category score may be a summation of the two numerical values from the two communications based answers. Alternatively, if there was a text based field in the form for “cultural fit” in candidate schema 136, then the translated numerical value of the text based field may be the cultural fit universal category score.

Other universal categories, and the variations of scoring the universal categories may be contemplated.

Organization database 148 stores a list of organizations that are looking for candidates, and basic information about the organization, including, but not limited to, the size of the organization, the industry that the organization operates in, and whether the organization won any employer awards. Other basic information about the organization may be contemplated. Organization database 148 also stores job description 152.

Job description 152 may be gathered through a graphical interface on hiring terminal 132. The graphical interface may present a form for the user of hiring terminal 132 to fill out. The form may request information regarding open employment position, including, but not limited to, the skills required for the job, the experience required for the job, or the importance of cultural fit for the job. Once the information is gathered on hiring terminal 132 as job description 152, job description 152 is sent via network 124 to communications interface 116. Job description 152 is then stored in organization database 148 in memory 112. Multiple job descriptions 152 may be related to a single record of an organization in organization database 148. For example, organization A in organization database 148 may have two job descriptions 152 looking for candidates.

Server 104 further includes processor 108, also referred to herein as a central processing unit (CPU), interconnecting memory 112 and communications interface 116. Memory 112 stores a plurality of computer-readable data and programming instructions accessible by processor 108, in the form of software objects. In the present embodiment, memory 112 stores candidate schemas 136, normalized schemas 140 and job descriptions 152, which may be used by processor 108 to execute operations and to interact with recommending terminals 128, and hiring terminals 132 via communications interface 116. It will now be recognized that various forms of computer-readable programming instructions stored in memory 112 can be executed by processor 108.

Server 104 further includes communications interface 116. Communications interface 116 allows server 104 to connect to other devices. Communications interface 116 can also connect processor 108 to input and output devices (not shown), such as a keyboard and mouse, as well as output devices, such as a display showing a user interface. Alternatively, or in addition, the input and output devices may be connected to processor 108 via communications interface 116 via another computing device. In other words, input and output devices can be local to server 104, or remote. It is recognized that there are a variety of methods of connecting processor 108 to communications interface 116.

Candidate exchange system 100 further includes network 124. Network 124 can include any one of or a combination of, a local area network (LAN) defined by one or more routers, switches, wireless access points or the like. Network 124 may also include any suitable wire area network (WAN) including cellular networks and the Internet.

Candidate exchange system 100 further includes recommending terminals 128. Recommending terminals 128 are connected to server 104 through network 124. Each recommending terminal 128 can be any suitable type of computing device, such as for example, a desktop computer, a laptop computer, a gaming console, a smartphone, tablets, or the like. Other suitable devices may be contemplated. Recommending terminals 128 display a graphical interface for the user of recommending terminal 128 to input information regarding a candidate that the user wishes to recommend. As previously described, recommending terminal 128 may also process information inputted as substantive data through the graphical interface and convert the substantive data into candidate schema 136.

Candidate exchange system 100 further includes hiring terminals 132. Hiring terminals 132 are connected to server 104 through network 124. Each hiring terminal 132 can be any suitable type of computing device, such as for example, a desktop computer, a laptop computer, a gaming console, a smartphone, tablets, or the like. Other suitable devices may be contemplated. Hiring terminals 132 display a graphical interface for the user of hiring terminal 132 to input information regarding an open employment position, that will then be sent as job description 152 to server 104 through network 124.

Hiring terminal 132 is further configured to receive candidate matches and normalized schemas 140 for candidates that matched with job description 152 from server 104, and display the normalized schemas 140 on a graphical interface. This provides the user of hiring terminal 132 with candidates that server 104 believes to be a good fit for job description 152. The information provided on the graphical interface of hiring terminal 132 aids the user of hiring terminal 132 to hiring a candidate for the open employment position. The determination of candidates that are a good fit will be further discussed below.

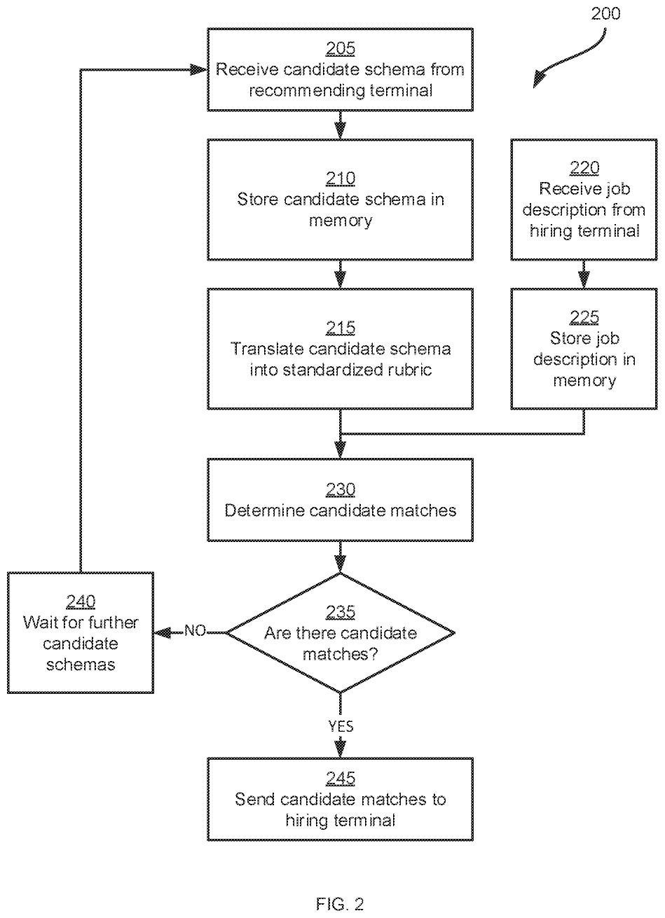

Referring to FIG. 2, an example method 200 for candidate exchange system 100 to provide candidate matches and normalized schemas 140 to hiring terminal 132 is depicted. Method 200 can be performed using candidate exchange system 100, although it is understood that method 200 can be performed on variations of candidate exchange system 100, and likewise it is to be understood that method 200 can be varied to accommodate variations on system 100.

At block 205, processor 108 receives candidate schema 136 from recommending terminal 128 through communications interface 116. As indicated above, candidate schema 136 includes formatted subjective data that is obtained from recommending terminal 128 through a graphical interface.

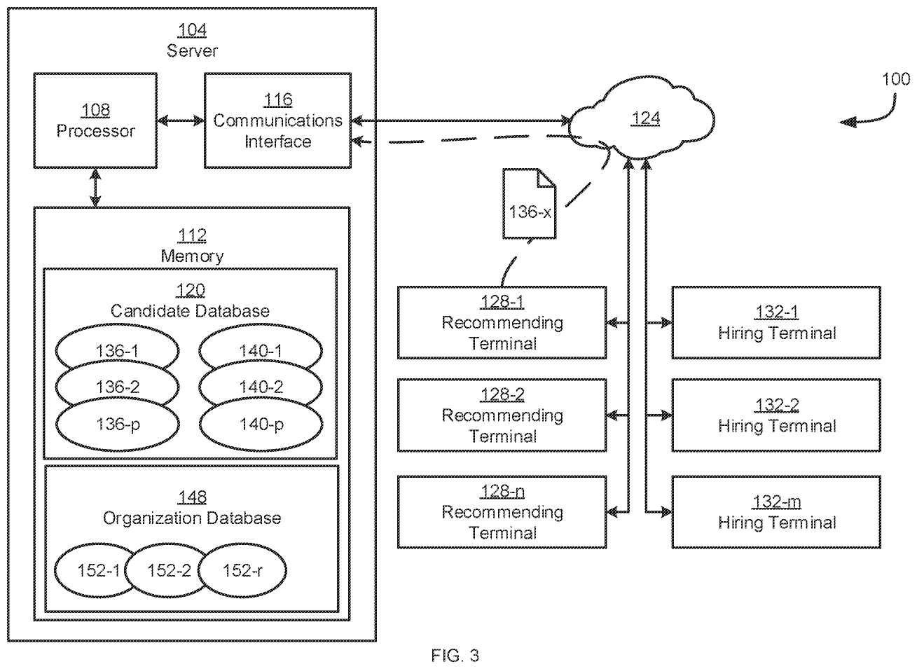

Referring to FIG. 3, an example candidate schema 136-x is being sent from recommending terminal 128-1 through network 124, to communications interface 116 in server 104. In this example, candidate schema 136-x may be related to an example candidate “John Doe”. Recommending terminal 128 submits a recommended candidate of “John Doe”, and the user of recommending terminal 128 interacts with a graphical interface on recommending terminal 128 to provide subjective data on “John Doe”. In this example, the subjective data is converted to candidate schema 136-x at recommending terminal 128-1, and candidate schema 136-x is sent to server 104 to be received by processor 108.

If a candidate being recommended by recommending terminal 128 already exists in candidate database 120, candidate schema 136 may be linked with the existing candidate record. There may be more than one candidate schema 136 linked with a single candidate in candidate database 120.

Returning to FIG. 2, at block 210, candidate schema 136 is stored in candidate database 120 in memory 112. Candidate schema 136 is associated with a corresponding candidate in candidate database 120. For example, if there were a candidate named “John Doe” that was recommended by recommending terminal 128, “John Doe” would be stored in candidate database 120 as a candidate. Candidate schema 136-x would be stored associated to the “John Doe” candidate record in candidate database 120.

At block 215, processor 108 translates candidate schema 136, which contains formatted subjective data, into normalized schema 140, which contains measurable data.

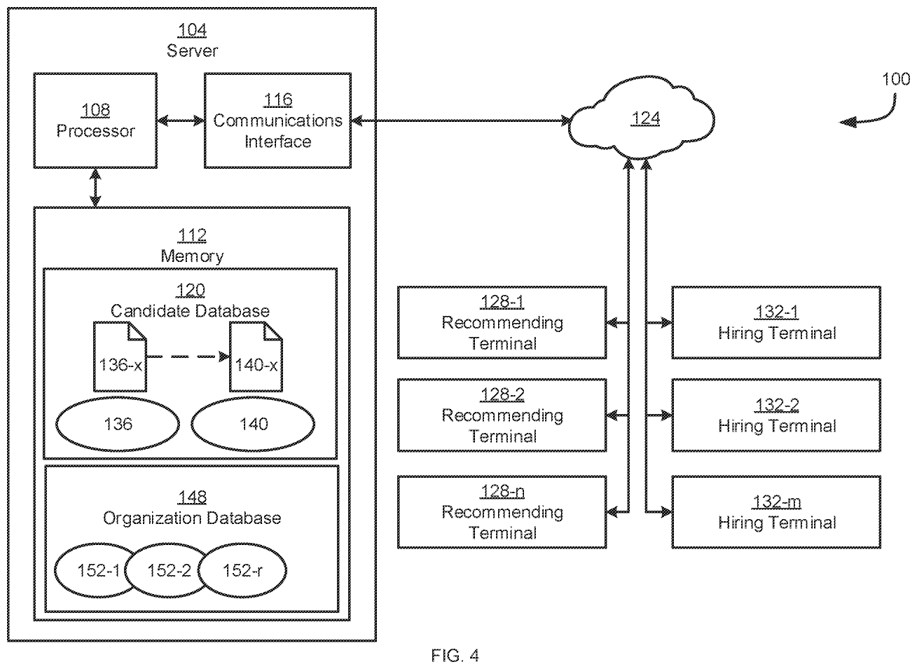

Referring to FIG. 4, example candidate schema 136-x resides in memory 112, and is translated by processor 108 into corresponding normalized schema 140-x, which also resides in candidate database 120 in memory 112. As indicated above, translating candidate schema 136 to normalized schema 140 may be accomplished through different methods, or a combination of different methods, including, but not limited to algorithms, scales or the use of machine learning or artificial intelligence.

In the event that there are multiple candidate schemas 136 for a single candidate record, the latest received candidate schema 136 may be translated into measurable data that may be incorporated into existing normalized schema 140. For example, if a first candidate schema 136 contains subjective data regarding a candidate being a good team player, and a second candidate schema 136 contains subjective data regarding a candidate being a bad team player, then normalized schema 140 may reflect a measurable data point that is in between a translated measurable data point of the first candidate schema 136 and the second candidate schema 136. For example, if “Jane Smith” were to have a translated measurable data point of four (4) from a first candidate schema, and a translated measurable data point of two (2) from a second candidate schema, then normalized schema 140 may use three (3) as the average score for that question or measurable quality of candidate “Jane Smith”. Universal category scores of normalized schema 140 may also be adjusted or recalculated based on the additional data from translating second candidate schema 136.

It will now occur to a person skilled in the art that a candidate may have more than one candidate schema 136, and that various combinations may be contemplated on translating and calculating measurable data for normalized schema 140.

Returning to FIG. 2, at block 220, processor 108 receives job description 152 from hiring terminal 132. Receipt of job description 152 by processor 108 from hiring terminal 132 occurs independently of the receipt of candidate schema 136 from recommending terminal 128, and may occur, before, after, or in parallel with the receipt of candidate schema 136. At block 225,

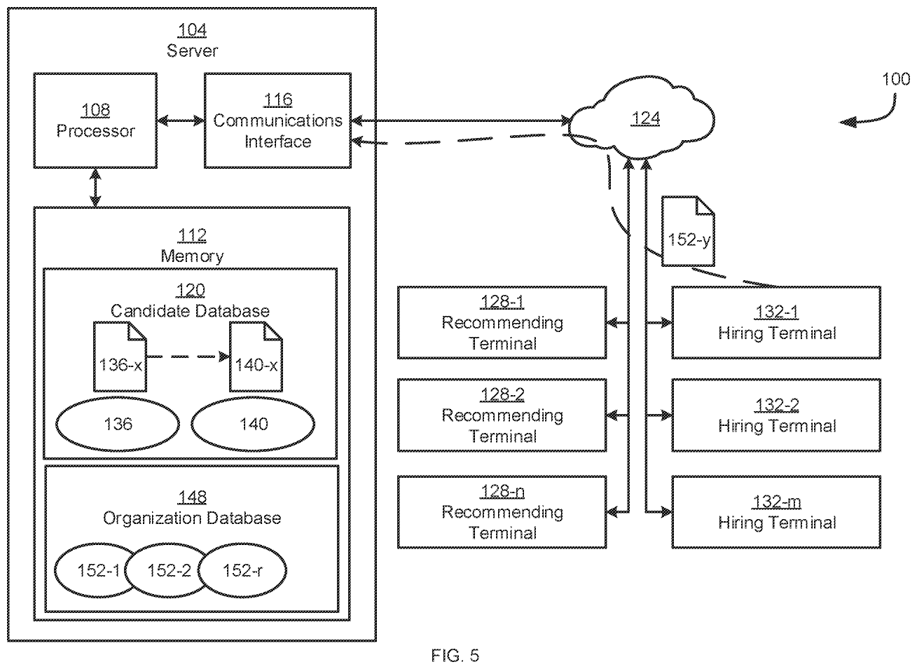

Referring to FIG. 5, example job description 152-y is sent from hiring terminal 132-1 through network 124 to be received at communications interface 116. In this example, the user at hiring terminal 132-1 is part of an example organization, “ABC Corp.” Hiring terminal 132-1 presents the user a hiring terminal 132-1 with a graphical interface, allowing the user to input details regarding an open employment position at “ABC Corp.” The information is collated as job description 152-y, and is sent to server 104 to be received by processor 108.

Returning to FIG. 2, at block 225, job description 152 is stored in organization database 148 in memory 112 and is linked to an organization record in organization database 148.

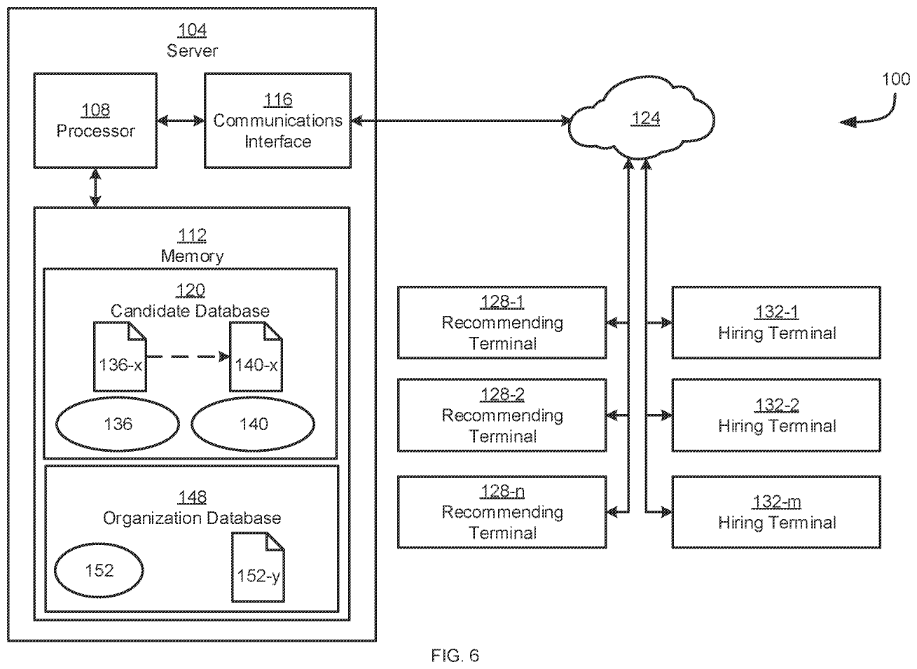

Referring to FIG. 6, example job description 152-y for “ABC Corp.” is stored in organization database 148 in memory 112. If “ABC Corp.” does not exist as an organization record in organization database 148, “ABC Corp.” may be added as an organization record. Job description 152-y is then linked to the “ABC Corp.” organization record.

If “ABC Corp,” already exists in organization database 148, then a new organization record does not need to be added to organization database 148, and job description 152-y can be linked to the existing organization record.

Returning to FIG. 2, at block 230, processor 108 determines candidate matches between normalized schema 140 and job description 152. Candidate matches may be performed algorithmically, or through the use of machine learning or artificial intelligence. For example, if job description 152 requires a candidate to have at least five (5) years of experience in a certain industry, then processor 108 will filter out candidates with less than five (5) years of experience in said industry. Alternatively, if job description 152 considers it an asset to have at least five (5) years of experience in a certain industry, then processor 108 will skew towards providing candidates with at least five (5) years of experience, but will not rule those without it out. Multiple factors may also be weighed differently and taken into account when performing matches. Weighing of the factors may depend on the details of the job description 152 as provided by hiring terminal 132.

Processor 108 may also use machine learning or artificial intelligence to determine candidate matches. For example, by training server 104 to recognize job descriptions 152 that match with normalized schemas 140 with certain measurable values in certain universal categories, processor 108 may provide candidate matches based on its training. As a further example, a trained processor 108 may recognize that job descriptions 152 that contain software development skew towards normalized schemas 140 with programming skills, and hence processor 108 may provide candidate matches of candidates with programming skills.

Job description 152 may also contain measurable data values as provided by hiring terminal 132. Algorithms may also be used by processor 108 to match measurable data values in job description 152 to measurable data values in normalized schema 140.

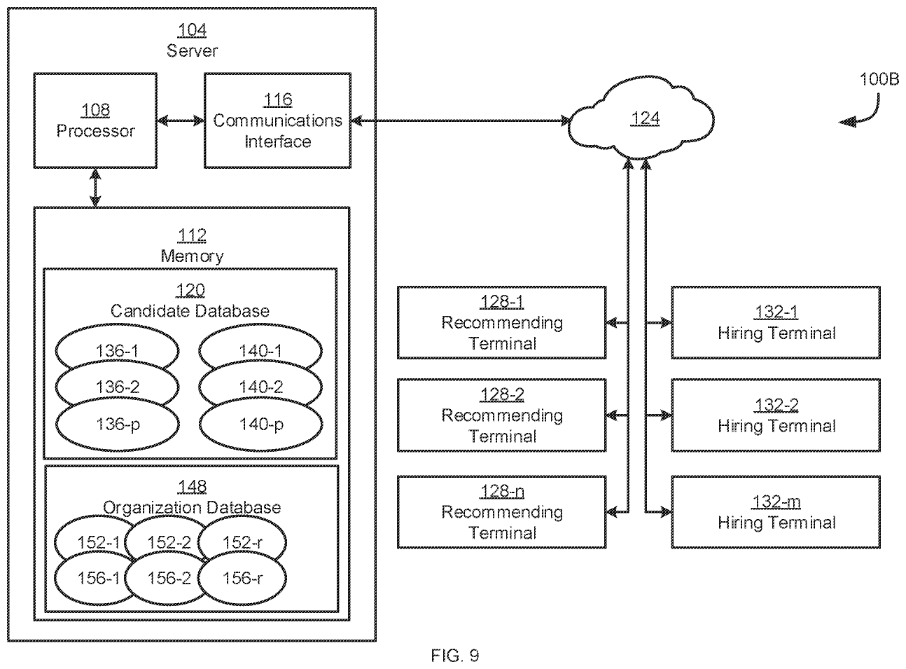

In other embodiments, job description 152 may be translated into job rubric 156 (as depicted in FIG. 9 showing example candidate exchange system 100B), where job description 152 may contain substantive information regarding the open employment position, and job rubric 156 may be translated from job description 152 into measurable data by processor 108. The translation process from job description 152 to job rubric 156 by processor 108 may use similar methods and techniques to those used by processor 108 when translating candidate schema 136 to normalized schema 140. The measurable values of job rubric 156 may then be algorithmically compared to normalized schema 140 for processor 108 to provide candidate matches.

Returning to FIG. 2, at block 235, processor 108 determines whether there are any candidate matches between normalized schema 140 and job description 152. If there are no candidate matches, processor 108 waits for further candidate schemas 136 from recommending terminals 128, as shown at block 240. When a new candidate schema 136 is received, the process starts over again at block 205.

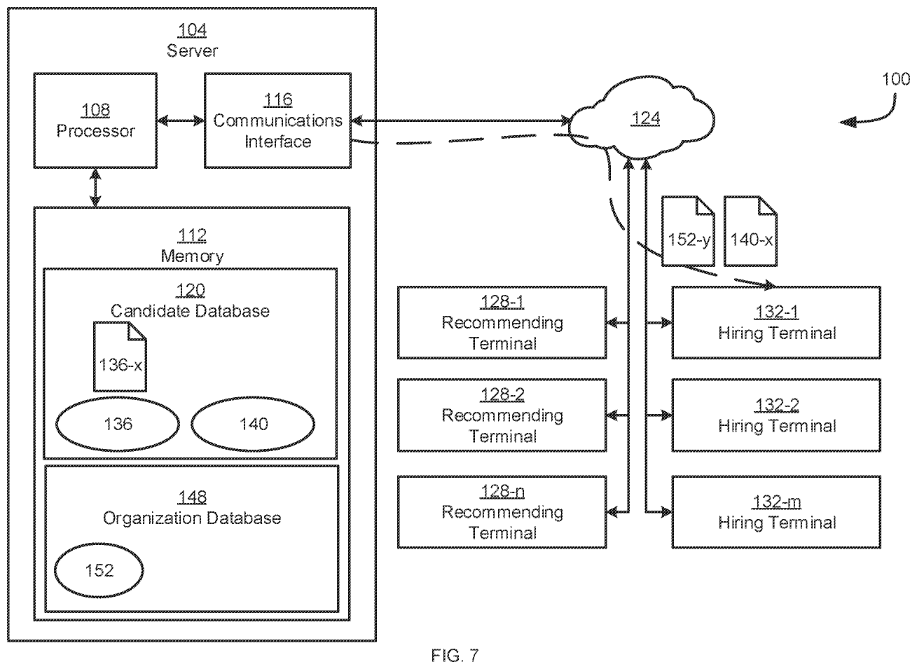

If there are candidate matches, the normalized schemas 140 of the candidate matches are sent to hiring terminal 132, at block 240, to be displayed on a graphical interface on hiring terminal 132. Referring to FIG. 7, an example of a matched candidate's normalized schema 140-x is sent from communications interface 116 through network 124 to hiring terminal 132-1.

By displaying candidate matches on a graphical interface on hiring terminal 132, the user on hiring terminal 132, who is trying to fill the open employment position that is represented by job description 152 is presented with choices for candidates that he or she can choose to fill the open employment position, with a greater confidence that the candidate being chosen has a good and valid recommendation.

In an alternative embodiment, candidate exchange system 100A may include candidate terminals 144. Candidate terminals 144 may provide an additional source of information for basic information of the candidate, or may provide additional subjective information for candidate schema 136. Candidate terminals 144 may be connected to server 104 through network 124. Candidate terminals 144 can be any suitable type of computing device, such as for example, a desktop computer, a laptop computer, a gaming console, a smartphone, tablets, or the like. Other suitable devices may be contemplated. Candidate terminals 144 display a graphical interface for the user of candidate terminal 144 to input information regarding the candidate.

In an alternative embodiment (not depicted), a monetary value may also be associated with either the candidate or with job description 152. To encourage the recommendation of candidates, a monetary value may be associated with the candidate, and if the candidate is selected for an open employment position by an organization, the organization may pay the monetary value to the user of the recommendation terminal 128. Similarly, job description 152 may have a monetary value associated with it. If the open employment position associated with job description 152 be filled, then the monetary value may be paid to the user of recommending terminal 128. The monetary value may also be referred herein as a referral fee.

It should be recognized that features and aspects of the various examples provided above can be combined into further examples that also fall within the scope of the present disclosure. In addition, the figures are not to scale and may have size and shape exaggerated for illustrative purposes.

1. A system for matching employers with potential employees, the system comprising:
a server comprising:
a memory configured to store a database of candidates, a candidate schema, the candidate schema configured to store subjective information about a candidate, and a normalized schema, the normalized schema configured to store measurable data about the candidate, each candidate schema and each normalized schema associated with the candidate in the database of candidates;
a processor configured to translate subjective information in the candidate schema into measurable data in the normalized schema, the processor further configured to determine candidate matches between the normalized schema and a job description for an employment position; and
a communications interface connected to a network, the communications interface configured to send and receive data regarding the job description and the candidate;
a recommending terminal connected to the server via the network, the recommending terminal configured to provide a graphical interface to gather subjective information about the candidate; and
a hiring terminal connected to the server via the network, the hiring terminal configured to provide a graphical interface to gather information about the job description, the hiring terminal further configured to display the candidate matches between the normalized schema and the job description, and the normalized schema for the candidate matches.

2. The system of claim 1, wherein the processor is further configured to use multiple weighted factors to determine candidate matches between the normalized schema and the job description for the employment position.

3. The system of claim 1, wherein the memory is further configured to store a monetary value associated with the candidate, wherein if the candidate is hired based on the candidate matches between the normalized schema and the job description, the monetary value is a referral fee provided from the hiring terminal to the recommending terminal.

4. The system of claim 1, the system further comprising a candidate terminal, the candidate terminal connected to the server via the network, the candidate terminal configured to provide a graphical interface to gather basic information regarding the candidate.

5. The system of claim 1, wherein the graphical interface gathering subjective information about the candidate on the recommending terminal displays a plurality of questions about the candidate.

6. The system of claim 5, wherein the plurality of questions about the candidate may vary between candidates to improve accuracy of information obtained about candidates based on feedback from matched candidates and employers.

7. A non-transitory computer-readable medium comprising instructions executable by a processor to:
receive a candidate schema from a recommending terminal through a communications interface, the candidate schema configured to store subjective information about a candidate;
store the candidate schema in memory, the memory configured to store the candidate schema and a database of candidates, the candidate schema associated with the candidate in the database of candidates;
translate the candidate schema into a normalized schema, the memory configured to further store the normalized schema, the normalized schema associated with a candidate in the database of candidates, the normalized schema configured to store measurable data about the candidate;
receive a job description for an employment position from a hiring terminal through the communications interface;
determine candidate matches between the normalized schema and the job description for the employment position; and
send the candidate matches to the hiring terminal through the communications interface to be displayed on a graphical interface on the hiring terminal.

8. The non-transitory computer-readable medium of claim 7, the processor further configured to determine candidate matches between the normalized schema and the job description for the employment position using multiple weighted factors.

9. The non-transitory computer-readable medium of claim 7, wherein the memory is further configured to store a monetary value associated with the candidate, wherein if the candidate is hired based on the candidate matches between the normalized schema and the job description, the monetary value is a referral fee provided from the hiring terminal to the recommending terminal.

10. The non-transitory computer-readable medium of claim 7, the processor further configured to receive basic information about the candidate from a candidate terminal through the communications interface, the candidate terminal configured to provide a graphical interface to gather basic information regarding the candidate.

11. The non-transitory computer-readable medium of claim 7, wherein the recommending terminal is configured to provide a graphical interface to gather subjective information about the candidate by displaying a plurality of questions about the candidate, the recommending terminal converting the subjective information into the candidate schema.

12. The non-transitory computer-readable medium of claim 11, wherein the plurality of questions about the candidate may vary between candidates to improve accuracy of information obtained about candidates based on feedback from matched candidates and employers.
